(19) United States
(12) Patent Application Publication
(10) Pub. No.: US 2004/0068213 A1
(43) Pub. Date: Apr. 8, 2004

(54) Controllable massage device

(76) Inventor: Hiroshi Fujisawa, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/674,528

(22) Filed: Oct. 1, 2003

(30) Foreign Application Priority Data
Oct. 2, 2002 (JP) 2002-289720

(51) Int. Cl. A61H 23/02

(52) U.S. Cl. 601/70; 601/72

(57) ABSTRACT

Disclosed is an improved massage device capable of controlling its vibrating strength to be most appropriate for a selected part of one's body to be massaged. It comprises a power supply and an electric motor having an eccentric weight fixed to its shaft, thereby making the shaft vibrate when the electric motor is energized by the power supply. The massage device further comprises a slide switch to put the electric motor in circuit with the power supply. The slide switch comprises a wire coil and a slidable brush to move over the series of circles of the wire coil, thereby making the motor vary its rotating speed with the instantaneous position of the brush on the series of circles.

### BACKGROUND OF THE INVENTION

1. Field of the Invention

The present invention relates to a massage device using an electric motor whose vibrating shaft causes the effect of pressing and rubbing of parts of one's body to relax the muscles.

2. Related Art

A conventional massage device uses an electric motor having an eccentric weight fixed to its shaft, thereby making the shaft vibrate and cause the massaging effect when the electric motor is energized, as disclosed in JP 7-299151 (A).

The conventional massage device, however, generates constant vibration, and is not capable of controlling the vibration to be most appropriate for relaxing the muscles at a selected part of one's body to be massaged.

One object of the present invention is to provide a massage device capable of controlling the electric motor to make the vibration most appropriate for relaxing the muscles of a selected part of one's body to be massaged.

### SUMMARY OF THE INVENTION

To attain this object a massage device comprising a power supply and an electric motor having an eccentric weight fixed to its shaft, thereby making the shaft vibrate when the electric motor is energized by the power supply, is improved according to the present invention in that it further comprises a slide switch to put the electric motor in circuit with the power supply, the slide switch comprising a wire coil and a slidable brush to move over the series of circles of the wire coil, thereby making the rotating speed of the motor shaft vary with the instantaneous position of the brush on the series of circles.

The massage device may comprise a cylindrical housing which is composed of a vibrator compartment accommodating the electric motor and the eccentric weight and a battery compartment accommodating the power supply and the slide switch. The cylindrical housing may have a head fixed to the vibrator compartment, the head having at least one semi-spherical projection formed on its surface.

The massage device may further comprise a cap detachably fixed to the head of the cylindrical housing. The cap may have a plurality of projections formed on its surface.

The slidable brush may be adapted to move step by step so that the rotating speed of the motor may change at three sequential steps. The slide switch may have a projection formed on its body, and an associated guide rail may have three recesses to catch the projection of the slide switch so that the rotating speed of the motor may change when the projection is caught by each of the sequential recesses. The power supply may be a battery.

According to the massage device of the present invention, the vibration can be controlled so as to be most appropriate for relaxing a selected part of one's body to be massaged by making the slide switch stop at a selected step.

Other objects and advantages of the present invention will be understood from the following description of a massage device according to one preferred embodiment of the present invention, which is shown in accompanying drawings.

### BRIEF DESCRIPTION OF THE DRAWING

FIG. 1 is a plane view of a massage device according to the present invention;

FIG. 2 is a front view of the massage device;

FIG. 3 is a perspective exploded view of the massage device;

FIG. 4 is a plane view of the massage device with the cap put on its head;

FIG. 5 is a perspective view of the battery compartment of the housing;

FIG. 6 is a perspective exploded view of the slide switch in the battery compartment of the housing;

FIG. 7 is an enlarged perspective view of the guide rail in the battery compartment of the housing;

FIG. 8 is an enlarged perspective view of the slide switch in the battery compartment; and

FIG. 9 is a sectional view of the massage device taken along the line 9-9 in FIG. 1.

### DETAILED DESCRIPTION OF PREFERRED EMBODIMENT

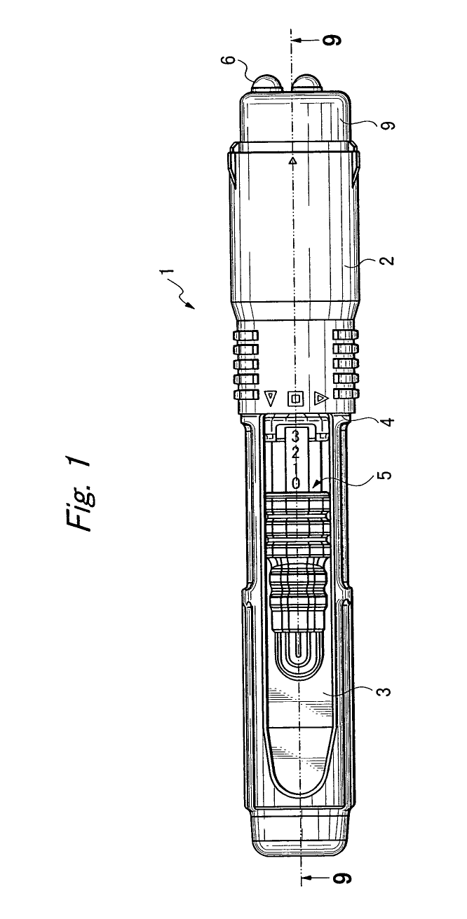

Referring to FIG. 1, a massage device 1 according to the present invention comprises a vibrator compartment 2, a battery compartment 3 and a joint section 4 which combines the vibrator compartment 2 and the battery compartment 3 together as a whole. The massage device is cylindrical in appearance.

The massage device 1 includes a power supply and an electric motor 8, which has an eccentric weight 11 fixed to its shaft 10 (see FIG. 3). The shaft 10 is made to vibrate when the electric motor 8 is energized by the power supply. A slide switch 5 is movably mounted in the battery compartment 3. It functions to connect or disconnect the electric motor 8 from the power supply, and control the electric motor 8 step by step every time it stops at Position 1, 2 or 3. When the slide switch 5 remains at Position 0, the electric motor 5 stops.

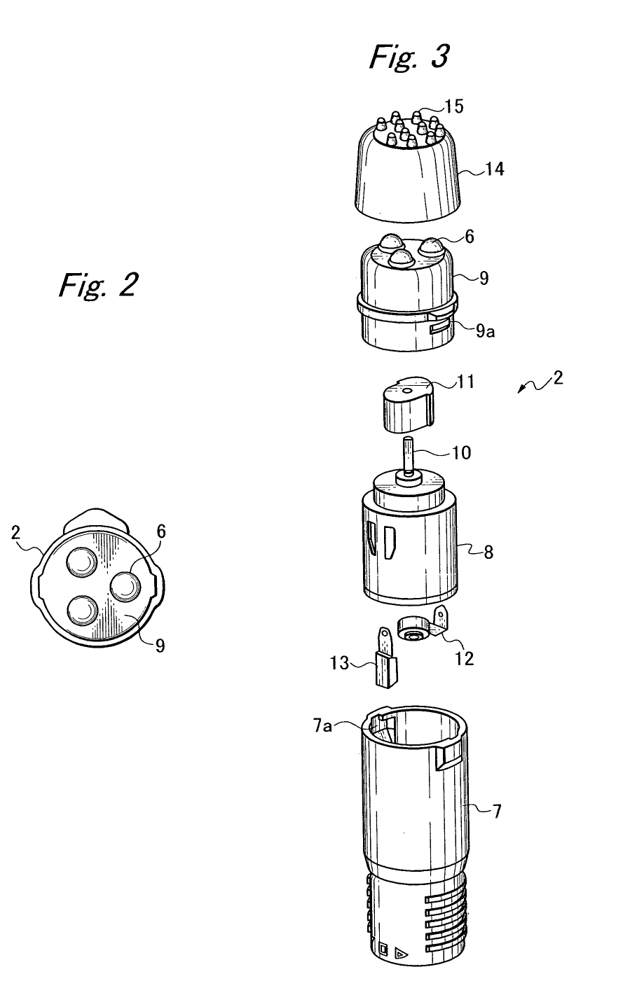

Referring to FIG. 2, the vibrator compartment 2 has a head 9 formed at its end, and the head 9 has three semi-spherical projections 6 formed on its top. Such semi-spherical projections 6 have the effect of stimulating and relaxing the muscles when the semi-spherical projections 6 are pushed against a selected vital point of one's body.

The number of the semi-spherical projections can be one. The semi-spherical projection 6 may be formed by making a semi-spherical projection separately and inserting it into a hole made on the head 9.

FIG. 3 is an exploded view of the vibrator compartment 2. As shown in the drawing, the vibrator compartment casing 7 is formed nearly cylindrical. The electric motor 8 is put in the casing 7, and then, the head 9 is fastened to the casing 7 by press-fitting its nail 9a into the counter recess 7a, which is made inside of the casing 7 close to its open end.

The eccentric weight 11 is fastened to the shaft 10 of the electric motor 8. The shaft 10 is press-fitted in the through hole of the eccentric weight 11. The electric motor 8 has positive and negative polarity terminals 12 and 13. When the battery supplies electric current to the electric motor 8 via the positive and negative polarity terminals 12 and 13, the electric motor 8 rotates its shaft 10.

The casing 7 has a male joint section formed at the tail end. The battery casing 16 has a female joint section 16a formed at the head end. These male and female joint sections together provide a bayonet connection 4 to combine the casings 7 and 16 as a whole. The cap 14 is detachably put on the head 9 (see FIG. 3). The cap 14 has a plurality of small semi-spherical projections 15 formed on its top for massaging mainly the head skin.

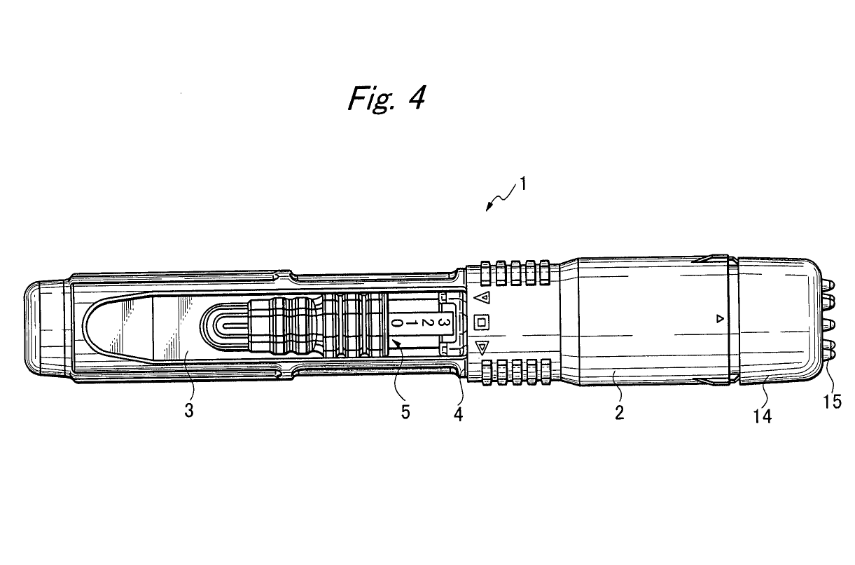

FIG. 4 shows the massage device 1 with the cap 14 put on its head 9. The projections 15 may take any shape other than the semi-spherical shape. The cap 14 takes two different roles; one is to protect the head 9, and the other is to cause a massaging effect different from the semi-spherical projections 6 of the head.

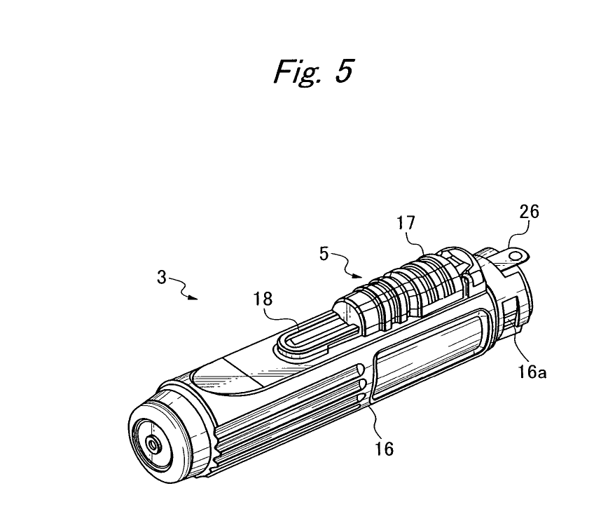

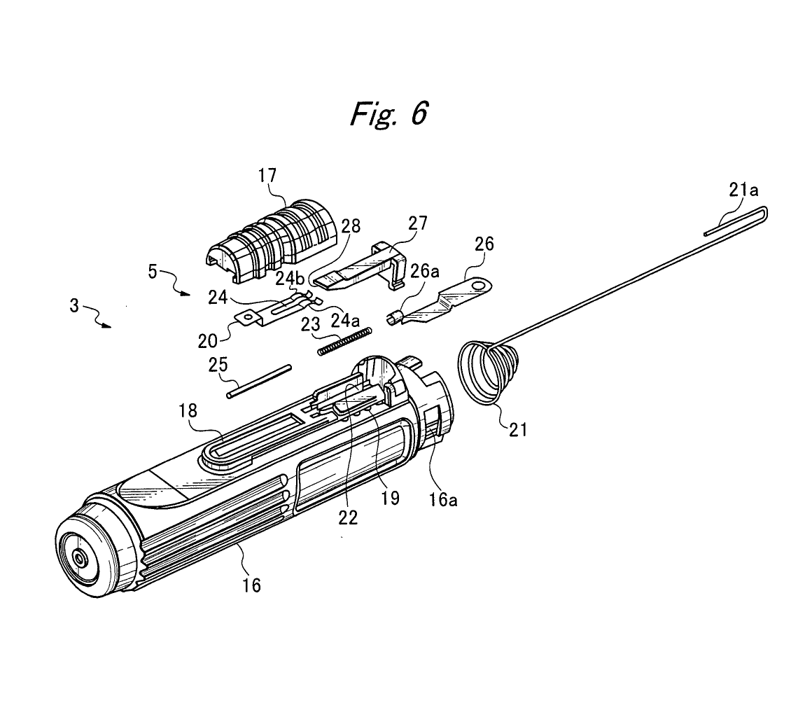

FIG. 5 is a perspective view of the battery compartment 3, and FIG. 6 is a perspective exploded view, showing the parts of the battery compartment 3. The battery casing 16 is equipped with the slide switch 17. It can move along an associated guide rail 18, which is built in the battery casing 16.

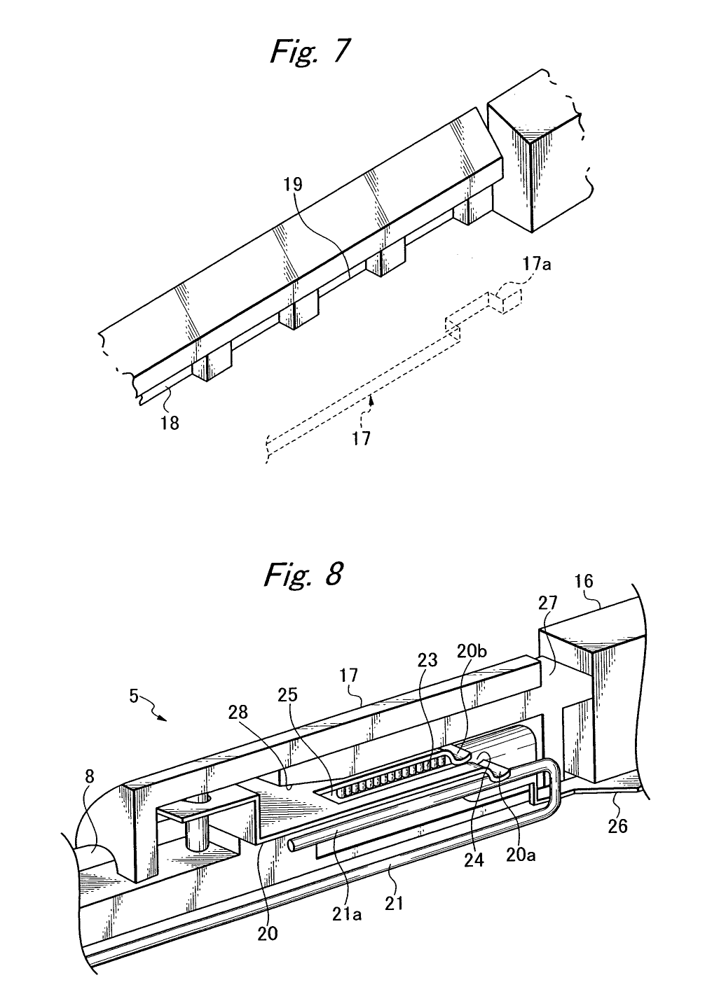

The slide switch 17 may be so designed that it may run over the full range without stopping. In this particular embodiment, however, the rail 18 have recesses 19 made at intervals, whereas the slide switch 17 has a projection 17a to be caught by any selected recess (see FIG. 7). Thus, the slide switch 17 can be made to stop sequentially to adjust the vibration at different levels, as later described in detail.

In this example three recesses 19 are made at regular intervals although they may be made at different intervals. The slide switch 17 can be made to stop at three different positions to control the vibration at three different levels.

Referring to FIG. 8, the slide switch 17 comprises a wire coil 23 and a slidable brush 20 to move over the series of circles of the wire coil, thereby changing the rotating speed of the motor shaft with the instantaneous position of the brush 20 on the series of circles of the wire coil 23. The brush 20 is a resilient plate-like bifurcate metal piece, which is made by cutting or punching a thin metal sheet into a required shape and by bending it.

A spring rod electrode 21 is wound in the spiral form at one end, and is bent in the hook-like shape at the other end. The spring rod electrode 21 is laid in the battery casing 16 with its hook-like end close to the vibrator compartment 2. The bent-back extension 21a of the hook-like end is used as the contact rod, on which the brush 20 moves.

The series of circles of the wire coil 23 are arranged parallel to the bent-back extension 21a of the hook-like end of the spring rod electrode 21. The bifurcate brush 20 is arranged to contact with its bifurcate contact arms on the contact rod 21a and the series of circles of the wire coil 23 respectively.

The bifurcate contact arms 24a and 24b of the slidable brush 24 extend parallel to each other, defining a slit 24 therebetween, and their forward ends 20a and 20b are somewhat bent upwards. The intervening slit 24 permits the opposite arms 24a and 24b to lie at different levels so that they may ride on the series of circles of the wire coil 23 and the bent-back extension 21a unless both are on the same level. The opposite arms 24a and 24b can move smoothly on the series of circles of the wire coil 23 and the bent-back extension 21a thanks to their curved ends 20a and 20b.

The wire coil 23 is of a metal wire which is approximately 0.2 mm in diameter, and is low in electric resistance such as SUS304 wire. It functions as an electric resistance. The voltage of the power supply is preferably below six volts in consideration of the heat generated by the wire coil 23 when electric current flows.

A thermal insulator rod core 25 is inserted in the cylindrical space, which is defined by the wire coil 23. The rod core 25 effectively prevents the circle-to-circle intervals of the wire coil 23 from changing. It may be made of a thermal insulating material such as Teflon (registered trade name).

The wire coil 23 is connected to the negative polarity terminal 13 of the electric motor 8 via the extending metal piece 26. When the vibrator compartment 2 and the battery compartment 3 are nested together by the bayonet joint section 4, the extending metal piece 26 comes to contact with the negative polarity terminal 13 of the electric motor 8. When the slidable brush 20 is moved forward to be in contact with the wire coil 23 and the bent-back extension 21a of the spring rod electrode 21, the electric motor 8 is put in circuit with the battery 29, and then the electric current flows from the positive to negative terminal of the battery 29 through the positive polarity terminal 12 of the electric motor 8, the negative polarity terminal 13 of the electric motor 8, the extending metal piece 26, the wire coil 23, the bifurcate arm 24b and bifurcate arm 24a of the slidable brush 20, the hook-like end and spiral end of the spring rod electrode 21.

In assembling and building the side switch 5 into the battery casing 3 the spring rod electrode 21, the coil-and-core 23, 25 and the extending metal piece 26 are put in the space 22 which is defined between the flat top of the battery casing 3 and the overlying switch dome 17, and a cantilever-like piece 27 is press-fitted in the space to close it. The switch dome 17 has the brush 20 fixed inside. As the switch dome 17 moves back and forth, the brush 20 moves back and forth on the wire coil 23 and the bent-back extension 21a.

The cantilever-like piece 27 is chamfered on the free end 28, allowing the brush 20 to crawl under the chamfered end 28 when the switch dome 17 is moved forward, and accordingly the brush 20 is pushed against the wire coil 23 and the bent-back extension 21a.

The annular female recess 16a of the bayonet joint 4 is made on the head end of the battery casing 3, whereas the annular male projection (not shown) is formed on the tail end of the vibrator casing 7. The battery casing 3 and the vibrator casing 7 are abutted on each other, and rotated in the opposite directions to combine as a whole.

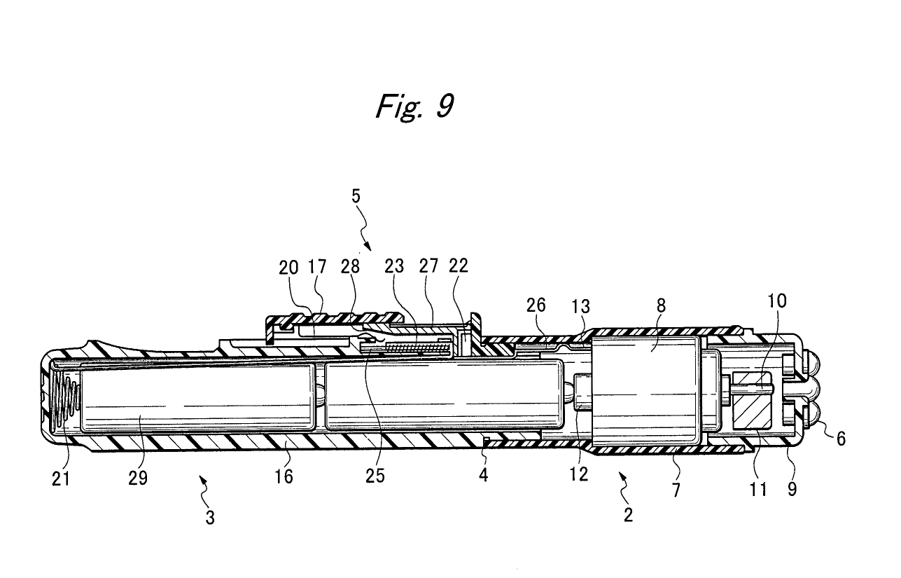

Referring to FIG. 9, two batteries 29 are series-connected in the battery compartment 3, and the positive terminal of the series-connected batteries is put in contact with the positive polarity terminal 12 of the electric motor 8 while the negative terminal of the series-connected batteries is pushed against the spiral end of the spring rod electrode 21.

When the bifurcate brush 20 is pushed forward to put its bifurcate arms 24a and 24b in contact with the bent-back extension 21a and the wire coil 23, the electric motor 8 is put in circuit with the series-connected batteries 29: the bent-back extension 21a is directly connected to the negative terminal of the series-connected batteries 29; the wire coil 23 is connected to the negative polarity terminal 13 of the electric motor 8 via the extending metal piece 26; and the positive terminal of the series-connected batteries 29 is pushed against the positive polarity of the electric motor 8 (Switch-on Position). Then, the electric motor 8 is supplied with electric power to rotate its shaft 10. When the bifurcate brush 20 is moved backward apart from the bent-back extension 21a and the wire coil 23, the electric motor 8 is disconnected from the power supply 29 (Switch-off Position).

The movable brush 20 moves along the series of circles 23 all the time while traveling from the Switch-on Position back to the Switch-off Position and vice versa, so that the electric resistance series-connected between the power supply 29 and the electric motor 8 may change with the instantaneous position of the movable brush on the series of circles of wire coil 23. Thus, the electric current flowing in the electric motor 8 may be controlled, and accordingly the rotating speed and torque of the electric motor 8 may be controlled.

In this particular embodiment the guide rail 8 has three recesses 19 to catch the movable brush 20 as it travels along the full length of the wire coil 23. Thus, the rotating speed of the electric motor 8 may be changed at three sequential steps.

The eccentric weight 11 is so fixed to the motor shaft 10 that its center of gravity may be apart from the motor shaft 10. The off-center arrangement causes the vibration in the massage device 1. The vibration can be controlled by moving back and forth the movable switch 17 to be most appropriate for a selected part of the person's body to be massaged.

Positioning the eccentric-biased motor as close to the head end of the cylindrical housing as possible permits the effective use of the generated vibration. The massaging effect can be enhanced by the semi-spherical projections of the head of the massage device.

The massage device can be turned into an electric toothbrush simply by joining a toothbrush to the motor shaft 10 if it is so modified.

What is claimed is:

1. A massage device comprising a power supply and an electric motor having an eccentric weight fixed to its shaft, thereby making the shaft vibrate when the electric motor is energized by the power supply, characterized in that it further comprises a slide switch to put the electric motor in circuit with the power supply, the slide switch comprising a wire coil and a slidable brush to move over the series of circles of the wire coil, thereby making the rotating speed of the motor shaft vary with the instantaneous position of the brush on the series of circles.

2. A massage device according to claim 1, wherein it comprises a cylindrical housing which is composed of a vibrator compartment accommodating the electric motor and the eccentric weight and a battery compartment accommodating the power supply and the slide switch.

3. A massage device according to claim 2, wherein the cylindrical housing has a head fixed to the vibrator compartment, the head having at least one semi-spherical projection formed on its surface.

4. A massage device according to claim 3, wherein it further comprises a cap detachably fixed to the head of the cylindrical housing.

5. A massage device according to claim 4, wherein the cap has a plurality of projections formed on its surface.

6. A massage device according to claim 1, wherein the slidable brush is adapted to move step by step so that the rotating speed of the motor may change at three sequential steps.

7. A massage device according to claim 6, wherein the slide switch has a projection formed on its body, and an associated guide rail has three recesses to catch the projection of the slide switch so that the rotating speed of the motor may change when the projection is caught by each of the sequential recesses.

8. A massage device according to claim 1 or 2, wherein the power supply is a battery.
